(19) United States
(12) Patent Application Publication
(10) Pub. No.: US 2005/0185042 A1
(43) Pub. Date: Aug. 25, 2005

(54) Multi-head gear pump and wet-type image forming apparatus employing the same

(75) Inventors: Sung-dae Kim, Suwon-si (KR); Yong su Kim, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/062,613

(22) Filed: Feb. 22, 2005

(30) Foreign Application Priority Data
Feb. 21, 2004 (KR) 2004-11675

(51) Int. Cl. B41J 2/39; B41J 2/395

(52) U.S. Cl. 347/141

(57) ABSTRACT

A multi-head gear pump including: a motor; first and second pumping heads, each of which includes a housing with an inlet and an outlet, and a pair of pumping gears meshing with each other within the housing and pumping a fluid from the inlet to the outlet while rotating. The first and second pumping heads are driven simultaneously by the motor. The first and second pumping heads have different pumping capacities.

### CROSS-REFERENCE TO RELATED APPLICATIONS

This application claims the priority of Korean Patent Application No. 2004-11675, filed on Feb. 21, 2004, in the Korean Intellectual Property Office, the disclosure of which is incorporated herein in its entirety by reference.

### BACKGROUND OF THE INVENTION

1. Field of the Invention

The present invention relates to a multi-head gear pump with a plurality of pumping heads, which are driven simultaneously by one motor, and a wet-type image forming apparatus employing the multi-head gear pump.

2. Description of the Related Art

In general, wet-type image forming apparatuses form an electrostatic latent image, which corresponds to a desired image, by radiating light on a photosensitive body, develop the electrostatic latent image with a liquid developer, a mixture of toner and carrier liquid, (referred to as ink hereinafter), and transfer, fix, and print the developed image. A wet-type image forming apparatus is provided with an ink pump unit, which is disposed between an ink cartridge and a developing unit to circulate the ink. The ink pump unit includes an ink supply pump for supplying ink from the ink cartridge to the developing unit, and an ink retrieval pump for retrieving the ink from the developing unit to the ink cartridge. To achieve uniform print quality, the ink pumps must be able to pump a fixed amount of ink at a constant speed. Further, a ratio of a pumping capacity to supplied electric power is high. To meet these conditions, gear pumps can be employed as the ink pumps.

A liquid color image forming apparatus for printing color images includes four developing units for developing cyan (C), magenta (M), yellow (Y), and black (B) colors, respectively, and four ink cartridges in which the four colors of ink are contained. Since the four colors of ink must not be mixed with one another, the liquid color image forming apparatus has paths through which the respective colors of ink can flow independently. Furthermore, ink supply and retrieval pumps must be provided for each color of ink. Accordingly, there is a concern that an ink circulating system might become too large.

The number of ink pumps must be reduced to scale down the ink circulating system. U.S. Pat. Nos. 5,466,131 and 5,540,569 each disclose a multi-head gear pump for an inkjet printer, including two pumping heads. The pump disclosed in the respective references is basically constructed such that fluids pumped by the two pumping heads are mixed together to remove a pressure difference between the two pumping heads. Accordingly, this pump is not suitable for a liquid color image forming apparatus with developing units and ink cartridges, in which four colors of ink must not be mixed with one another.

### SUMMARY OF THE INVENTION

Accordingly, it is an aspect of the present invention to provide a multi-head gear pump, which has a high pumping capacity with respect to supplied electric power, and can pump a fixed amount of ink at a constant speed.

It is also an aspect of the present invention to provide a multi-head gear pump with pumping heads, which have different pumping capacities and directions from one another.

It is also an aspect of the present invention to provide a wet-type image forming apparatus employing the multi-head gear pump, which can reduce the burden of controlling ink pumps and guarantee uniform print quality.

Additional aspects and/or advantages of the invention will be set forth in part in the description which follows and, in part, will be obvious from the description, or may be learned by practice of the invention.

According to an aspect of the present invention, there is provided a multi-head gear pump, including a motor; first and second pumping heads, each including a housing including an inlet and an outlet, and a pair of pumping gears meshing with each other within the housing and pumping a fluid from the inlet to the outlet while rotating, the first and second pumping heads being driven simultaneously by the motor, wherein the first and second pumping heads have different pumping capacities.

According to another aspect of the present invention, there is provided a wet-type image forming apparatus including: a photosensitive body on which an electrostatic latent image is formed; first through fourth developing units, each of which supplies a developer to the electrostatic latent image and develops the electrostatic latent image; first through fourth ink cartridges in which first through fourth colors of ink are contained, respectively; first through fourth ink supply paths and first through fourth ink retrieval paths, which connect respectively the first through fourth ink cartridges to the first through fourth developing units; and a plurality of multi-head gear pumps, which are connected to the first through fourth ink supply paths and the first through fourth ink retrieval paths and to circulate the ink between the first through fourth developing units and the first through fourth ink cartridges, each of the plurality of multi-head gear pumps including a motor, and a plurality of pumping heads, each of which includes a housing with an inlet and an outlet, and a pair of pumping gears meshing with each other within the housing and pumping the respective ink from the inlet to the outlet, the plurality of pumping heads being driven simultaneously by the motor, wherein the pumping heads connected to the first through fourth ink retrieval paths have a pumping capacity higher than the pumping heads connected to the first through fourth ink supply paths.

### BRIEF DESCRIPTION OF THE DRAWINGS

The above and/or other aspects and advantages of the present invention will become more apparent by describing in detail exemplary embodiments thereof with reference to the attached drawings in which:

FIG. 1 is a cross-sectional view of a multi-head gear pump according to an exemplary embodiment of the present invention;

FIG. 2 is a detailed sectional view of a pumping head of FIG. 1;

FIG. 3 is a cross-sectional view of an embodiment of a power transfer unit of FIG. 1;

FIG. 4 is a cross-sectional view of another embodiment of a power transfer unit of FIG. 1;

FIG. 5 is a cross-sectional view of still another embodiment of a power transfer unit of FIG. 1;

FIG. 6 is a cross-sectional view of a multi-head gear pump according to another exemplary embodiment of the present invention;

FIG. 7 is a cross-sectional view of a multi-head gear pump according to still another exemplary embodiment of the present invention;

FIGS. 8A through 8D are cross-sectional views of exemplary embodiments of a multi-head gear pump with three pumping heads according to the present invention;

FIGS. 9A through 9C are cross-sectional views of exemplary embodiments of a multi-head gear pump with four pumping heads according to the present invention;

FIG. 10 is a diagram of a wet-type image forming apparatus according to an exemplary embodiment of the present invention;

FIG. 11 is a diagram of an embodiment of an ink circulating system employing four multi-head gear pumps each with two pumping heads according to the present invention;

FIG. 12 is a diagram for explaining the relationship between a structure in which ink supply and retrieval paths are connected to pumping heads and directions in which pumping heads pump ink, according to the present invention;

FIG. 13 is a diagram of another embodiment of an ink circulating system employing two multi-head gear pumps each with three pumping heads and one multi-head gear pump with two pumping heads according to the present invention;

FIG. 14 is a diagram of still another embodiment of an ink circulating system employing two multi-head gear pumps each with four pumping heads according to the present invention; and

FIG. 15 is a diagram of yet another embodiment of an ink circulating system employing two multi-head gear pumps each with four pumping heads according to the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention will now be described more fully with reference to the accompanying drawings, in which preferred embodiments of the invention are shown.

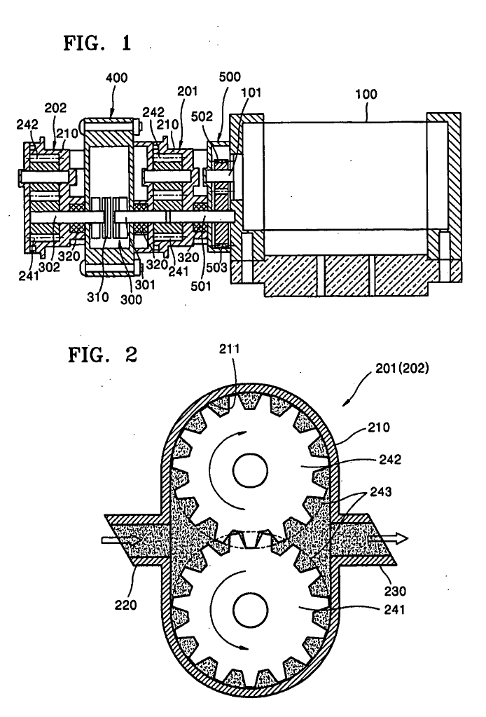

FIG. 1 is a cross-sectional view of a multi-head gear pump according to an exemplary embodiment of the present invention. Referring to FIG. 1, a multi-head gear pump includes a motor 100, which has a first rotational shaft 101, and first and second pumping heads 201 and 202, which are aligned serially. Reference numeral 300 denotes a power transfer unit and reference numeral 400 denotes a buffer chamber.

Referring to FIG. 2, each of the first and second pumping heads 201 and 202 includes a housing 210, which has an inlet 220 and an outlet 230, and a pair of pumping gears 241 and 242, which mesh with each other and rotate within the housing 210. The pair of pumping gears 241 and 242 rotate while maintaining a minimum clearance with an inner wall 211 of the housing 210. If the pair of pumping gears 241 and 242 rotate respectively in arrow directions shown in FIG. 2, a fluid enters from the inlet 220, passes through a space between the inner wall 211 of the housing 210 and teeth of the pair of pumping gears 241 and 242, and exhausts to the outlet 230. In order to prevent the forcedly pumped fluid from leaking through the clearance between the inner wall 211 of the housing 210 and peripheral portions 243 of the teeth of the pair of pumping gears 241 and 242, a sealing member (not shown) may be further provided to elastically contact the inner wall 211 of the housing 210 and the peripheral portions 243 of the teeth of the pair of pumping gears 241 and 242.

The first pumping head 201 is connected operatively to the first rotational shaft 101 of the motor 100. Referring to FIG. 1, reference numeral 500 denotes a reduction unit. In general, the torque of the motor 100 is reduced and then is transferred to the first pumping head 201. The first pumping head 201 may alternately be connected directly to the first rotational shaft 101 of the motor 100. A driven shaft 501 passes through the central part of the pumping gear 241 of the first pumping head 201. The driven shaft 501 extends beyond the housing 210, and the reduction unit 500 includes gears 502 and 503, which are engaged with the first rotational shaft 101 and the driven shaft 501, respectively. It goes without saying that the gear 503 should have more teeth than the gear 502 to reduce the torque of the motor 100. The construction of the reduction unit 500 is not restricted to the present embodiment, and the scope of the present invention is not limited to the reduction unit 500 described with reference to FIG. 1. In the above structure, the first pumping head 201 is connected operatively to the first rotational shaft 101 of the motor 100. A sealing member 320 is provided between the driven shaft 501 and the housing 210.

The power transfer unit 300 is disposed between the first and second pumping heads 201 and 202. The power transfer unit 300 transfers the torque of one of the pair of pumping gears 241 and 242 of the first pumping head 201 to one of the pair of pumping gears 241 and 242 of the second pumping head 202 so that the first and second pumping heads 201 and 202 can be driven simultaneously by the motor 100. Referring to FIG. 1, the power transfer unit 300 includes a first connecting shaft 301 and a second connecting shaft 302. The first connecting shaft 301 has one end passing through the central part of the pumping gear 241 of the first pumping head 201 and the other end extending into the inside of the buffer chamber 400. The second connecting shaft 302 has one end passing through the central part of the pumping gear 241 of the second pumping head 202 and the other end extending into the inside of the buffer chamber 400. The first and second connecting shafts 301 and 302 are substantially concentric. The other ends of the first and second connecting shafts 301 and 302 are spaced apart from each other. The sealing member 320 is provided between the housing 210 of the first and second pumping heads 201 and 202 and the first and second connecting shafts 301 and 302.

In reality, the first and second connecting shafts 301 and 302 cannot be perfectly concentric. For example, the first and second connecting shafts 301 and 302 are eccentric to some degree within a tolerance range. In this case, if the first and second connecting shafts 301 and 302 are rigidly connected, vibrations and noise may occur due to the eccentricity between the first and second connecting shafts 301 and 302, and the two shafts 301 and 302 or the pumping gears 241 and 242 may be damaged. Accordingly, the other ends of the first and second connecting shafts 301 and 302 are connected by a flexible coupler 310. The flexible coupler 310 serves to connect the first and second connecting shafts 301 and 302 flexibly, although the two shafts 301 and 302 are eccentric to some degree. Since the flexible coupler 310 is well known to one of ordinary skill in the art, a detailed explanation thereof will not be given. In the above structure, the motor 100 drives simultaneously the first and second pumping heads 201 and 202. Although not shown in the drawing, it is possible that one end of the first connecting shaft 301 passes through the central part of the pumping gear 242 of the first pumping head 201, and the one end of the second connecting shaft 302 passes through the central part of the pumping gear 242 of the second pumping head 202.

The first pumping head 201 and the second pumping head 202 may pump different fluids. In this instance, the two fluids must not be mixed together. To this end, the buffer chamber 400 is disposed between the first pumping head 201 and the second pumping head 202 to isolate the first pumping head 201 and the second pumping head 202 from each other. Although the sealing member 320 is used, some fluid may leak along the first and second connecting shafts 301 and 302 out of the first and second pumping heads 201 and 202. The buffer chamber 400 accommodates the power transfer unit 300 thereinside to prevent the fluids from leaking.

According to the exemplary embodiment illustrated in FIG. 1, since the pair of pumping gears 241 and 242 of the first pumping head 201 and the pair of pumping gears 241 and 242 of the second pumping head 202 rotate at the same speed, they have the same pumping capacity. The first and second pumping heads 201 and 202 can have pumping capacities different from each other by making modules of the pair of pumping gears 241 and 242 of the first pumping head 201 different from modules of the pair of pumping gears 241 and 242 of the second pumping head 202. Referring to FIG. 2, the fluids are pumped through the space between the inner wall 211 of the housing 210 and the teeth of the pair of pumping gears 241 and 242. If the modules are changed, the size of the teeth is changed. Accordingly, although the pumping gears 241 and 242 of the first and second pumping heads 201 and 202 rotate at the same speed, the pumping capacities thereof become different from each other. Further, the first and second pumping heads 201 and 202 can have different pumping capacities by making the number of teeth of the pumping gears 241 and 242 of the first pumping head 201 different from that of the pumping gears 241 and 242 of the second pumping head 202. Furthermore, the first and second pumping heads 201 and 202 can have different pumping capacities by making the thickness of the pair of pumping gears 241 and 242 of the first pumping head 201 different from the thickness of the pair of pumping gears 241 and 242 of the second pumping head 202. The thicker pumping gears allow the greater pumping capacity.

The first and second connecting shafts 301 and 302 may be arranged in parallel with each other, as shown in FIG. 3. In this case, the first and second connecting shafts 301 and 302 may be connected operatively to each other by a plurality of connecting gears. Referring to FIG. 3, the first connecting shaft 301 has one end passing through the central part of the pumping gear 242 of the first pumping head 201 and the other end extending into the inside of the buffer chamber 400. The second connecting shaft 302 has one end passing through the central part of the pumping gear 241 of the second pumping head 202 and the other end extending into the inside of the buffer chamber 400. The other ends of the first and second connecting shafts 301 and 302 are engaged respectively with first and second gears 321 and 322. The first and second gears 321 and 322 mesh with each other. Accordingly, the motor 100 drives simultaneously the first and second pumping heads 201 and 202. Although not shown in the drawing, it is also possible that the one end of the first connecting shaft 301 passes through the central part of the pumping gear 241 of the first pumping head 201 and the end of the second connecting shaft 302 passes through the central part of the pumping gear 242 of the second pumping head 202.

According to the power transfer unit 300 depicted in FIGS. 1 and 3, the pair of pumping gears 241 and 242 of the first pumping head 201 and the pair of pumping gears 241 and 242 of the second pumping head 202 rotate in the same direction. Accordingly, the first and second pumping heads 201 and 202 pump fluids in the same direction. The power transfer unit 300 may be constructed so that the first and second pumping heads 201 and 202 can pump fluids in directions opposite to each other.

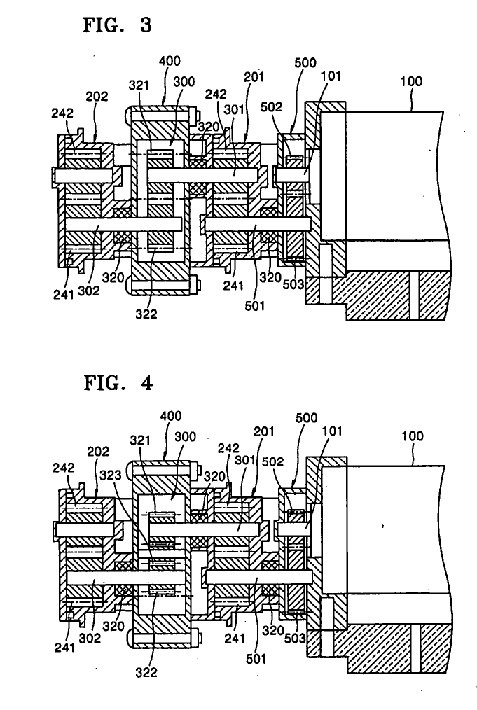

Referring to FIG. 4, the other ends of the first and second connecting shafts 301 and 302 are engaged respectively with the first and second gears 321 and 322. The first and second gears 321 and 322 are connected operatively to each other by an idle gear 323. A plurality of idle gears 323 may be used. If the number of the idle gears 323 is odd, the first pumping head 201 and the second pumping head 202 pump fluids in opposite directions.

According to the power transfer unit 300 depicted in FIGS. 3 and 4, the first and second pumping heads 201 and 202 can have pumping capacities different from each other by making a rotational speed of the pair of pumping gears 241 and 242 of the first pumping head 201 different from a rotational speed of the pair of pumping gears 241 and 242 of the second pumping head 202. For example, the number of teeth of the first and second gears 321 and 322 may be changed, or a double-step gear may be used as the idle gear 323. Even in this case, the modules, thickness, and number of teeth of the pumping gears 241 and 242 of the first pumping head 201 can be made different from those of the pumping gears 241 and 242 of the second pumping head 202 as well.

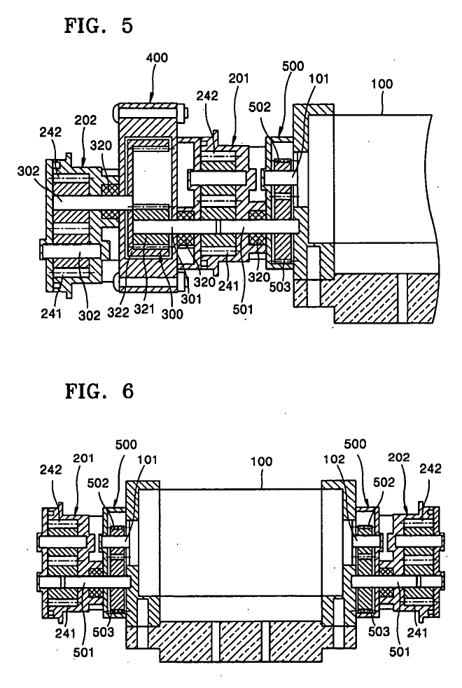

Referring to FIG. 5, the first connecting shaft 301 has one end passing through the central part of the pumping gear 241 of the first pumping head 201 and the second connecting shaft 302 has one end passing through the central part of the pumping gear 242 of the second pumping head 202. The first connecting shaft 301 has the other end engaged with the first gear 321 and the second connecting shaft 302 has the other end engaged with the second gear 322. The second gear 322 is an internal gear, and the first gear 321 is an external gear meshing with the second gear 322. In the above structure, the first pumping head 201 and the second pumping head 202 pump fluids in opposite directions. Moreover, since the second gear 322 has more teeth than the first gear 321, the pair of pumping gears 241 and 242 of the second pumping head 202 rotate slower than the pair of pumping gears 241 and 242 of the first pumping head 201. Consequently, the second pumping head 202 has a pumping capacity lower than the first pumping head 201.

Components that are the same as those in FIGS. 1 through 5 are given the same reference numerals, and descriptions thereof are omitted.

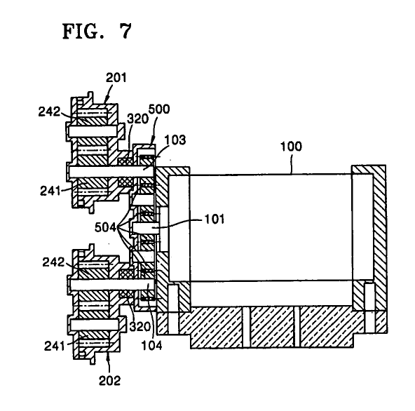

FIGS. 6 and 7 are cross-sectional views of other exemplary embodiments of a multi-head gear pump according to the present invention.

Referring to FIG. 6, the motor 100 has the first and second rotational shafts 101 and 102 disposed on both sides thereof. The first and second pumping heads 201 and 202 are operatively connected respectively to the first and second rotational shafts 101 and 102. Here, the reduction units 500 may be interposed respectively between the first shaft 101 and the first pumping head 201 and between the second rotational shaft 102 and the second pumping head 202. The first and second pumping heads 201 and 202 can have different pumping directions and pumping capacities from each other by making reduction rates of the two reduction units 500 different from each other. Further, the first and second pumping heads 201 and 202 can have different pumping capacities from each other by making modules and thicknesses of the pumping gears 241 and 242 thereof different from each other.

Referring to FIG. 7, third and fourth rotational shafts 103 and 104 are parallel to each other and are connected operatively to the first rotational shaft 101 of the motor 100. The third and fourth rotational shafts 103 and 104 are connected operatively to the first rotational shaft 101 by the reduction unit 500. For example, the reduction unit 500 may include a plurality of gears 504. In the embodiment illustrated in FIG. 7, the third rotational shaft 103 passes through the central part of the pumping gear 241 of the first pumping head 201, and the fourth rotational shaft 104 passes through the central part of the pumping gear 242 of the second pumping head 202. The first and second pumping heads 201 and 202 can have pumping directions different from each other when the reduction unit 500 connects the third and fourth rotational shafts 103 and 104 so that the third and fourth rotational shafts 103 and 104 can rotate at different speeds by controlling the number of teeth of the plurality of gears 504. In addition, the first and second pumping heads 201 and 202 can have different pumping capacities when the reduction unit 500 connects the third and fourth rotational shafts 103 and 104 so that the third and fourth rotational shafts 103 and 104 can rotate in different directions by changing the number of the plurality of gears 504 of the first rotational shaft 101 and the third and fourth rotational shafts 103 and 104. Moreover, the first and second pumping heads 201 and 202 can have different pumping capacities by making modules and thickness of the pumping gears 241 and 242 of the first and second pumping heads 201 and 202 different from each other.

According to the exemplary embodiments illustrated in FIGS. 6 and 7, the first and second pumping heads 201 and 202 are completely isolated from each other, thereby preventing fluids from being mixed together.

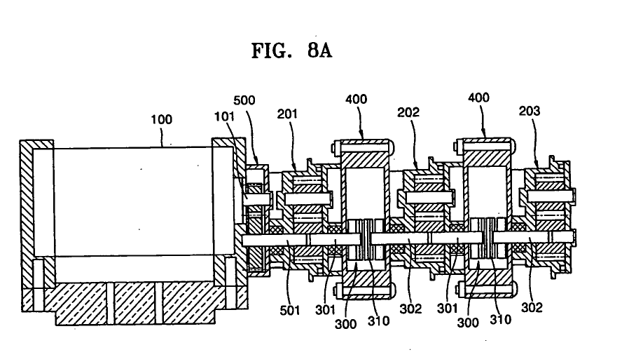

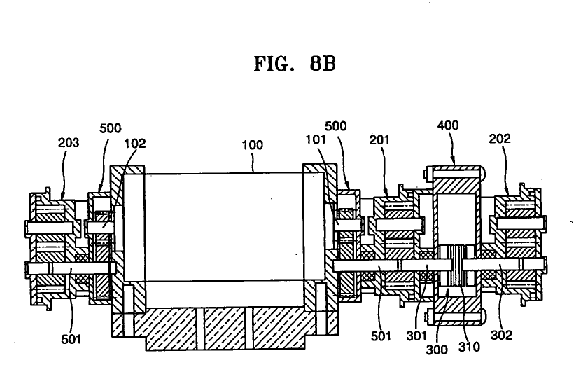

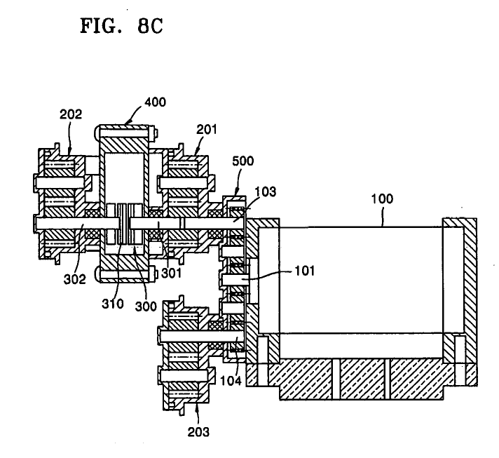

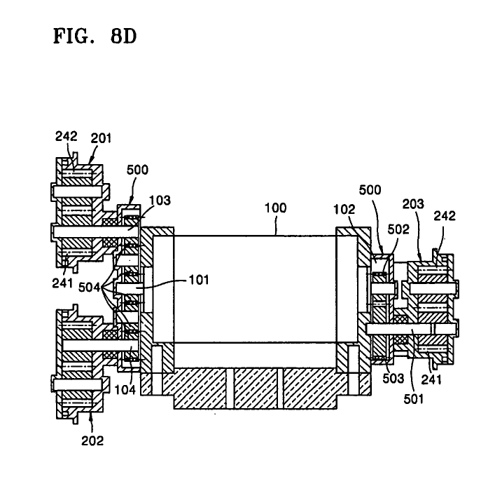

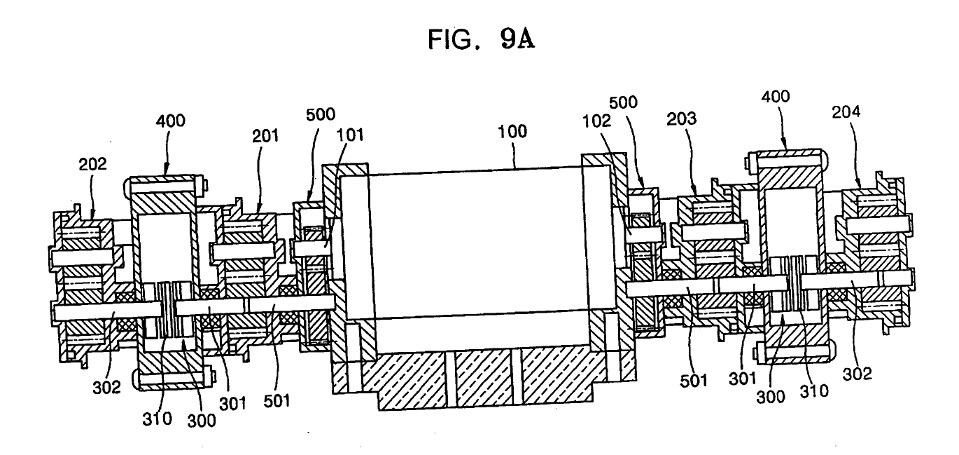

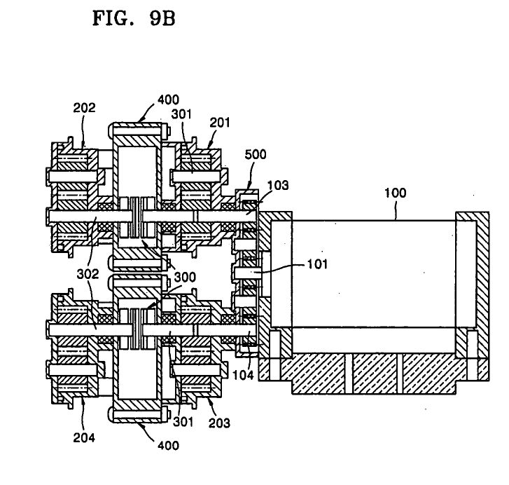

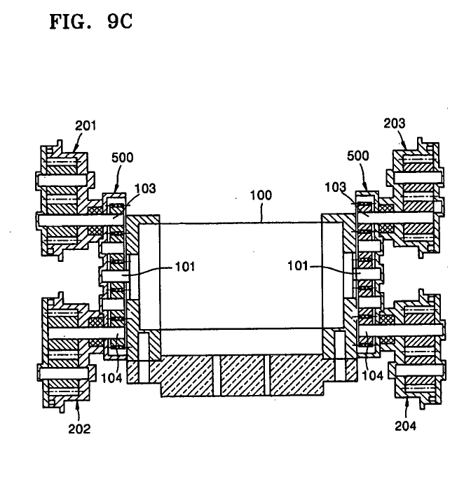

Although the multi-head gear pump with two pumping heads was described in the previous embodiments illustrated in FIGS. 1 through 7, the present invention is not restricted thereto. A multi-head gear pump according to the present invention may be provided with three or more pumping heads. Exemplary embodiments of a multi-head gear pump with three pumping heads 201, 202, and 203 are shown in FIGS. 8A through 8D. Exemplary embodiments of a multi-head gear pump with four pumping heads 201, 202, 203, and 204 are shown in FIGS. 9A through 9C. In the embodiments illustrated in FIGS. 8A through 8D and FIGS. 9A through 9C, a precedent pumping head and a subsequent pumping head are isolated from each other by a buffer chamber 400, and are connected operatively to each other by a power transfer unit 300. Further, the power transfer unit 300 is accommodated in the buffer chamber 400 to prevent fluid leakage. The construction of the multi-head gear pump according to the present invention is not restricted to the embodiments illustrated in FIGS. 8A through 8D and FIGS. 9A through 9C.

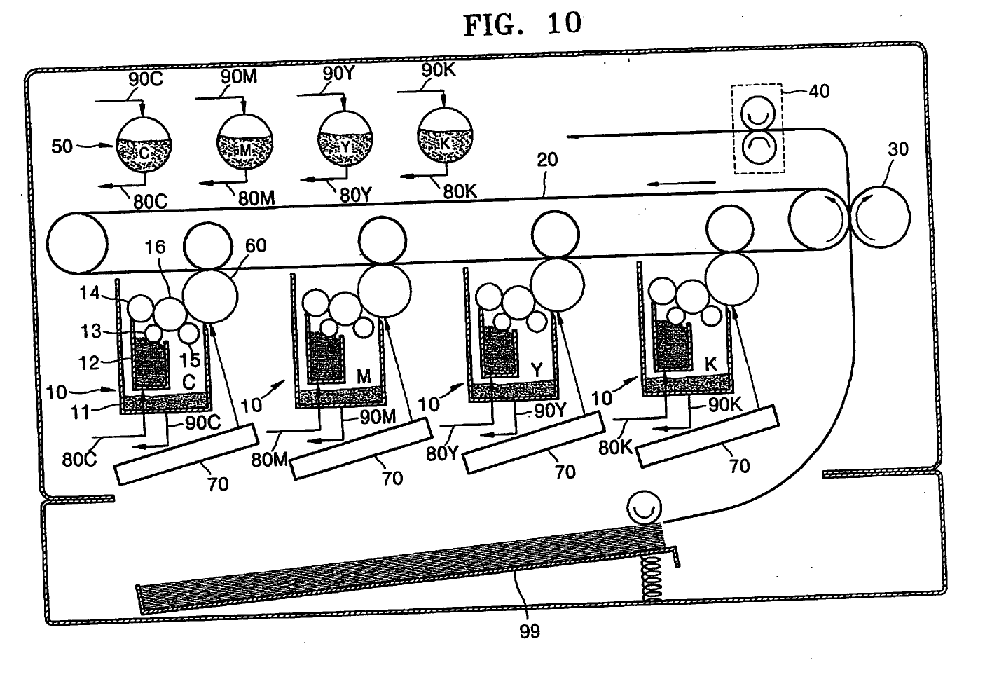

FIG. 10 is a diagram of a wet-type image forming apparatus according to an exemplary embodiment of the present invention. Referring to FIG. 10, a wet-type image forming apparatus includes first through fourth developing units 10C, 10M, 10Y, and 10K for developing cyan, magenta, yellow, and black colors, a circulating transfer belt 20, transfer rollers 30, and fixing units 40. First through fourth ink cartridges 50C, 50M, 50Y, and 50K contain cyan, magenta, yellow, and black colors of ink that are to be supplied respectively to the first through fourth developing units 10C, 10M, 10Y, and 10K. Reference numeral 60 denotes photosensitive drums. Exposure units 70 emit light to the photosensitive drums 60 to form latent images. Developing rollers 16 supply ink to the latent images and develop the latent images. The wet-type image forming apparatus according to the present invention is not restricted to the arrangements of the developing units and the ink cartridges illustrated in FIG. 10.

Referring to FIG. 10, a second ink container 12 is installed inside a first ink container 11 of each developing unit. A deposit roller 13 is installed in the second ink container 12 to attach ink to the surface of the developing roller 16. A cleaning roller 14 removes ink remaining on the surface of the developing roller 16, and a metering roller 15 regulates ink smeared on the developing roller 16. In the above structure, a latent image is formed on the photosensitive drum 60 by the exposure unit 70, and is developed with ink supplied by the developing roller 16. The developed image is transferred to the transfer belt 20.

The first through fourth developing units 10C, 10M, 10Y, and 10K transfer cyan, magenta, yellow, and black images to the transfer belt 20 in a predetermined order such that the four color images are laid on top of one another. The images are transferred to a paper that is supplied from a cassette 99, is conveyed to the transfer belt 20, and passes between the transfer rollers 30. The paper to which the images are transferred is subjected to a fixing process with heat and pressure while passing between the fixing units 40, thereby completing an image printing process.

The image forming apparatus is different from an inkjet printer in that the whole amount of ink supplied from the ink cartridge 50 to the developing unit 10 is used for the printing process. Further, more ink than necessary for the actual printing process must be supplied to the developing unit 10 to get a high quality print job, and ink remaining after the printing process must be retrieved from the developing unit 10. Accordingly, during an image forming process, ink is supplied from the ink cartridge 50 to the second ink container 12, and part of ink overflowing the second ink container 12 is collected in the first ink container 11 and then is returned to the ink cartridge 50. While those operations are repeated, the multiple colors of ink must circulate without being mixed together. To this end, the wet-type image forming apparatus forms first through fourth ink supply paths 80C, 80M, 80Y, and 80K that connect the ink cartridges 50C, 50M, 50Y, and 50K to the second ink containers 12, respectively, and first through fourth ink retrieval paths 90C, 90M, 90Y, and 90K that connect the ink cartridges 50C, 50M, 50Y, and 50K to the first ink containers 11, respectively.

The image forming apparatus employs a gear pump to forcedly feed ink. The amount of circulating ink is approximately 500 cc/min or more. The present gear pump can feed such a large amount of ink and still be small enough to be embedded in the image forming apparatus. The gear pump has the advantage of a high pumping capacity to supplied electric power ratio and can pump a fixed amount of ink at a constant speed. The wet-type image forming apparatus of the respective embodiments illustrated in FIGS. 1 through 6, FIGS. 8A through 8D, and FIGS. 9A through 9C employs a multi-head gear pump with two or more pumping heads.

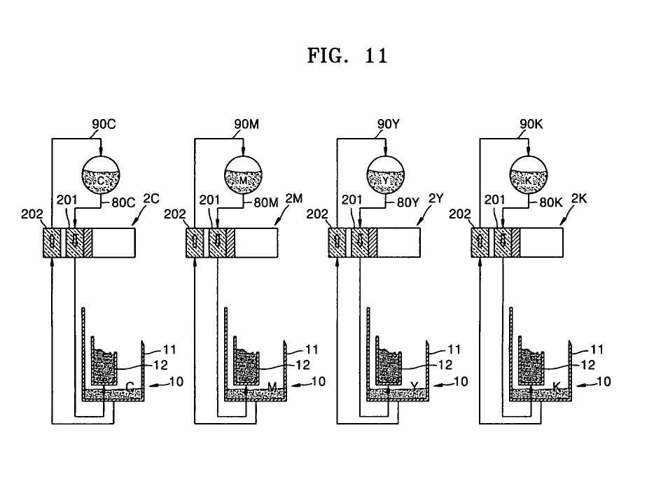

FIGS. 11 through 15 are diagrams of embodiments of an ink circulating system using a multi-head gear pump. Reference numerals 201, 202, 203, and 204 simply represent individual pumping heads, but do not show exact positions and arrangements of the pumping heads.

FIG. 11 is a diagram of an embodiment of an ink circulating system employing four multi-head gear pumps each with two pumping heads. Although the ink circulating system of the present embodiment illustrated in FIG. 11 adopts the multi-head gear pump shown in FIG. 1, it will be appreciated by one of ordinary skill in the art that the multi-head gear pumps shown in FIGS. 6 and 7 can be adopted.

Referring to FIG. 11, each of first through fourth multi-head gear pumps 2C, 2M, 2Y, and 2K includes first and second pumping heads 201 and 202. The first pumping heads 201 of the first through fourth multi-head gear pumps 2C, 2M, 2Y, and 2K are connected respectively to first through fourth ink supply paths 80C, 80M, 80Y, and 80K, and the second pumping heads 202 of the first through fourth multi-head gear pumps 2C, 2M, 2Y, and 2K are connected respectively to first through fourth ink retrieval paths 90C, 90M, 90Y, and 90K.

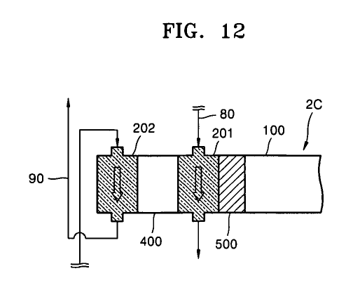

In this case, the first pumping head 201 and the second pumping head 202 pump ink in different directions. If the first and second pumping heads 201 and 202 pump ink in the same direction, as shown in FIG. 12, a structure in which the ink retrieval path 90 and the second pumping head 202 are connected becomes complex and occupies a large space. Additionally, the second pumping head 202 has a pumping capacity higher than the first pumping head 201. If the second pumping head 202 has a pumping capacity lower than the first pumping head 201, the level of ink contained in the first ink container 11 rises gradually, and thus, the ink may leak out of the first ink container 11.

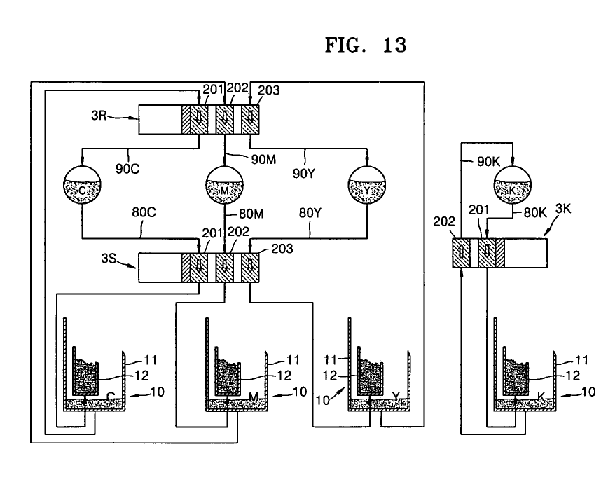

FIG. 13 is a diagram of another embodiment of an ink circulating system employing two multi-head gear pumps each with three pumping heads and one multi-head gear pump with two pumping heads. Although the ink circulating system of the present embodiment illustrated in FIG. 13 adopts the multi-head gear pump shown in FIG. 8A and FIG. 1, it will be appreciated by one of ordinary skill in the art, that the multi-head gear pumps shown in FIGS. 6, 7, and 8B through 8D can be adopted.

Referring to FIG. 13, each of first and second multi-head gear pumps 3S and 3R has first, second, and third pumping heads 201, 202, and 203, and a third multi-head gear pump 3K has first and second pumping heads 201 and 202. The three pumping heads 201, 202, and 203 of the first multi-head gear pump 3S are connected respectively to first through third ink supply paths 80C, 80M, and 80Y, and the three pumping heads 201, 202, and 203 of the second multi-head gear pump 3R are connected respectively to first through third ink retrieval paths 90C, 90M, and 90Y. The first pumping head 201 of the third multi-head gear pump 3K is connected to a fourth ink supply path 80K, and the second pumping head 202 of the third multi-head gear pump 3K is connected to a fourth ink retrieval path 90K. In this case, the second multi-head gear pump 3R has a pumping capacity higher than the first multi-head gear pump 3S. Also, the second pumping head 202 of the third multi-head gear pump 3K has a pumping capacity higher than the first pumping head 201 of the third multi-head gear pump 3K.

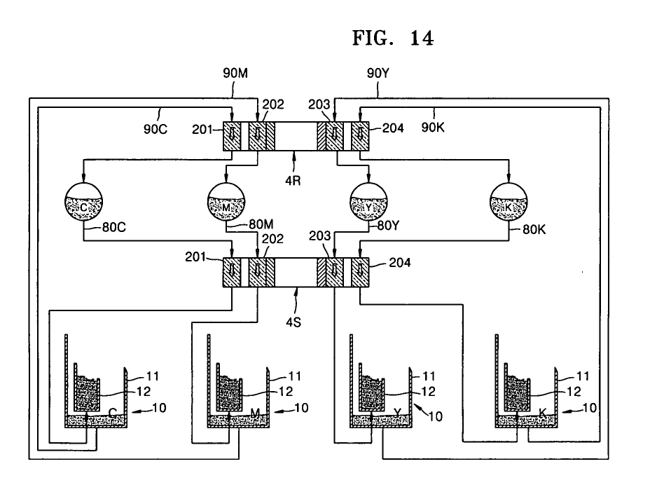

FIG. 14 is a diagram of still another embodiment of an ink circulating system employing two multi-head gear pumps each with four pumping heads. Although the ink circulating system of the embodiment illustrated in FIG. 14 adopts the multi-head gear pump shown in FIG. 9A, it will be appreciated by one of ordinary skill in the art, that the multi-head gear pumps shown in FIGS. 9B and 9C can be adopted.

Referring to FIG. 14, each of first and second multi-head gear pumps 4S and 4R has first through fourth pumping heads 201, 202, 203, and 204. The four pumping heads 201, 202, 203, and 204 of the first multi-head gear pump 4S are connected respectively to first through fourth ink supply paths 80C, 80M, 80Y, and 80K, and the four pumping heads 201, 202, 203, and 204 of the second multi-head gear pump 4R are connected respectively to first through fourth ink retrieval paths 90C, 90M, 90Y, and 90K.

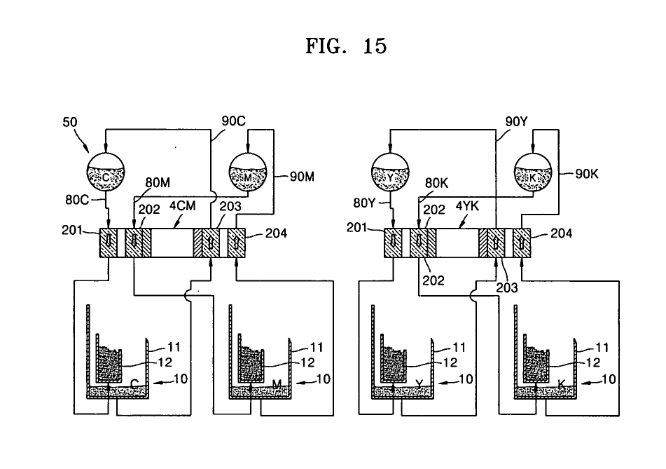

FIG. 15 is a diagram of yet another embodiment of an ink circulating system employing two multi-head gear pumps each with four pumping heads.

Referring to FIG. 15, first and second pumping heads 201 and 202 of a first multi-head gear pump 4CM are connected respectively to first and second ink supply paths 80C and 80M, and third and fourth pumping heads 203 and 204 of the first multi-head gear pump 4CM are connected respectively to first and second ink retrieval paths 90C and 90M. First and second pumping heads 201 and 202 of a second multi-head gear pump 4YK are connected to third and fourth ink supply paths 80Y and 80K, and third and fourth pumping heads 203 and 204 of the second multi-head gear pump 4YK are connected respectively to third and fourth ink retrieval paths 90Y and 90K. In this case, the third and fourth pumping heads 203 and 204 have a pumping capacity higher than the first and second pumping heads 201 and 202, and have a pumping direction different from the first and second pumping heads 201 and 202.

In general, a wet-type color image forming apparatus requires eight ink pumps to circulate ink between four ink cartridges and four developing units. In this case, the detecting and controlling operations of the respective pumps are very complex. According to the exemplary embodiments described with reference to FIGS. 11 through 15, ink can be circulated with only four, three, or two ink pumps. Accordingly, the burdens of detecting and controlling the operations of the respective ink pumps are drastically reduced. It is further efficient if all four colors of the ink are circulated to print color images and only black ink is circulated to print black images. According to the exemplary embodiment illustrated in FIG. 13, the third multi-head gear pump 3K for circulating black ink can be driven alone. According to the exemplary embodiment illustrated in FIG. 15, black images can be printed by driving only the second multi-head gear pump 4YK. Further, since the plurality of pumping heads are aligned in such a manner that a preceeding pumping head is isolated from a subsequent pumping head by a buffer chamber, ink fluids pumped by the two pumping heads are not mixed together. In addition, since the power transfer unit is accommodated in the buffer chamber, ink overflowing the pumping head is prevented from leaking outwardly, and accordingly, the wet-type image forming apparatus is not contaminated.

As described above, according to the multi-head gear pump of the present invention, the plurality of pumping heads can be driven by one motor. Furthermore, the plurality of pumping heads that have pumping directions and capacities different from one another can be driven by one motor.

Also, if the multi-head gear pump is applied to a wet-type image forming apparatus, the number of required ink pumps can be reduced. Accordingly, the operations of the ink pumps can be detected and controlled more easily.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A multi-head gear pump comprising:
a motor; and
first and second pumping heads, each comprising:
a housing comprising an inlet and an outlet, and
a pair of pumping gears meshing with each other within the housing and pumping a fluid from the inlet to the outlet while rotating,
the first and second pumping heads being driven simultaneously by the motor,
wherein the first and second pumping heads have different pumping capacities.

2. The multi-head gear pump of claim 1, wherein the first and second pumping heads pump the respective fluids in different directions.

3. The multi-head gear pump of claim 1, wherein the pair of pumping gears of the first pumping head and the pair of pumping gears of the second pumping head have different modules.

4. The multi-head gear pump of claim 1, wherein the pair of pumping gears of the first pumping head and the pair of pumping gears of the second pumping head have different thicknesses.

5. The multi-head gear pump of claim 1, wherein the pair of pumping gears of the first pumping head and the pair of pumping gears of the second pumping head have different rotational speeds.

6. The multi-head gear pump of claim 5, further comprising:
a first connecting shaft, comprising an end passing through a central part of one of the pair of pumping gears of the first pumping head;
a second connecting shaft, comprising an end passing through a central part of one of the pair of pumping gears of the second pumping head; and
a plurality of connecting gears, comprising an internal gear to connect the first connecting shaft to the second connecting shaft.

7. The multi-head gear pump of claim 6, further comprising a buffer chamber, which is disposed between the first and second pumping heads and isolates the first and second pumping heads from each other,
wherein the first and second connecting shafts and the plurality of connecting gears are accommodated in the buffer chamber.

8. The multi-head gear pump of claim 5, further comprising:
a first connecting shaft, which has an end passing through a central part of one of the pair of pumping gears of the first pumping head;
a second connecting shaft, which has an end passing through a central part of one of the pair of pumping gears of the second pumping head; and
a plurality of connecting gears, comprising a double-step gear and to connect the first connecting shaft to the second connecting shaft.

9. The multi-head gear pump of claim 8, further comprising a buffer chamber, which is disposed between the first and second pumping heads and isolates the first and second pumping heads from each other,
wherein the first and second connecting shafts and the plurality of connecting gears are accommodated in the buffer chamber.

10. The multi-head gear pump of claim 5, wherein the motor includes first and second rotational shafts at both ends thereof, the multi-head gear pump further comprising a first plurality of reduction units to operatively connect the first and second pumping heads respectively to the first and second rotational shafts, the first reduction units having different reduction rates.

11. The multi-head gear pump of claim 10, further comprising:
third and fourth rotational shafts, which are parallel to each other; and
a second plurality of reduction units, which operatively connect the third and fourth rotational shafts to the first rotational shaft of the motor,
wherein the first and second pumping heads are operatively connected respectively to the third and fourth rotational shafts, the second reduction units have different reduction rates and connect operatively the third and fourth rotational shafts to the first rotational shaft.

12. A wet-type image forming apparatus comprising:
a photosensitive body on which an electrostatic latent image is formed;
first through fourth developing units, each of which supplies an ink to the electrostatic latent image and develops the electrostatic latent image;
first through fourth ink cartridges in which first through fourth colors of the ink are contained, respectively;
first through fourth ink supply paths and first through fourth ink retrieval paths, which connect respectively the first through fourth ink cartridges to the first through fourth developing units; and
a plurality of multi-head gear pumps, which are connected to the first through fourth ink supply paths and the first through fourth ink retrieval paths and to circulate the ink between the first through fourth developing units and the first through fourth ink cartridges, each of the plurality of multi-head gear pumps comprising:
a motor, and
a plurality of pumping heads, each of which is connected to either a respective one of the ink retrieval paths or a respective one of the ink supply paths and includes a housing with an inlet and an outlet, and a pair of pumping gears meshing with each other within the housing and pumping the respective ink from the inlet to the outlet, the plurality of pumping heads each being driven simultaneously by the motor,
wherein the pumping heads connected to the first through fourth ink retrieval paths have a pumping capacity higher than the pumping heads connected to the first through fourth ink supply paths.

13. The wet-type image forming apparatus of claim 12, wherein the pumping heads connected to the ink retrieval paths pump the ink and the pumping heads connected to the ink supply paths pump the ink in directions opposite to each other.

14. The multi-head gear pump of claim 7, wherein the buffer chamber prevents the respective fluids of the pumping heads from mixing.

15. A gear pump comprising:
first and second pumping heads, each comprising:
a first pumping gear, and
a second pumping gear meshing with the first pumping gear to pump a fluid,
wherein the fluids of the first and second pumping heads are not mixed.

16. The multi-head gear pump of claim 15, further comprising:
a power transfer unit to transfer a power of the first pumping head to the second pumping head; and
a buffer unit to accommodate the power transfer unit so that the fluids of the first and second pumping heads which leak along the power transfer unit are contained.

17. The multi-head gear pump of claim 16, wherein each of the pumping heads further comprises a housing to contain the respective first and second pumping gears, the multi-head gear pump further comprising a sealing member between the housings and the power transfer unit.

18. The multi-head gear pump of claim 16, wherein the power transfer unit comprises first and second shafts to respectively connect the first pumping gears of the first and second pumping heads and the second pumping gears of the first and second pumping heads.

19. The multi-head gear pump of claim 18, wherein the power transfer unit further comprises a flexible connector to connect ends of the first and second shafts.
